(19) United States
(12) Patent Application Publication
(10) Pub. No.: US 2018/0370053 A1
(43) Pub. Date: Dec. 27, 2018

(54) Stiles Honed Blade and Apparatus for Same

(71) Applicant: Sharidan L Stiles, Redding, CA (US)

(72) Inventor: Sharidan L Stiles, Redding, CA (US)

(21) Appl. No.: 15/630,616

(22) Filed: Jun. 22, 2017

(51) Int. Cl. B26B 21/56; B26B 21/22; B26B 21/40; B26B 21/58

(52) U.S. Cl. CPC B26B 21/56; B26B 21/225; B26B 21/4043; B26B 21/58; B26B 21/4012

(57) ABSTRACT

A Honed Blade Apparatus of a razor head having at least one honed blade and a handle connected thereto; and a honed blade for incorporation into a razor head is disclosed, the blades being of a width ranging from 0.1 inches to 1.0 inches. These honed blades of the unique widths are perfect for the exfoliation and/or shaving of the Bikini area, Groin area, Body area, Scalp area, and Facial areas which include: (Goatee, Beard, Sideburns, Lip, Ear, Eyebrow, Nose, Cheeks & Forehead), and Toes & Knuckles.

### BACKGROUND OF THE INVENTION

Attention is called to United States Letters Patents. Each of which was examined and found to be different from the instant teaching.

| | | | | | |
|---|---|---|---|---|---|
| 4,379,219; | 4,488,357, | 4,492,024; | 4,498,235; | 4,551,916; | 4,573,266; |
| 4,586,255; | 4,587,729; | 4,621,424; | 4,709,476; | 4,742,909; | 4,756,082; |
| 4,807,401; | 4,916,817; | 5,063,667; | 5,113,585; | 5,157,835; | 5,192,712; |
| 5,249,361; | 5,399,204; | 5,578,114; | 5,687,485; | 5,800,627; | D306,216; |
| D312,568; | D316,962; | D349,242; | D363,142; | D370,844; | D373,444; |
| D381,121 | 9,108,329; | US2002/0157258 | | | |

This present invention is based & evolved from the disclosure filed with the USPTO office December 1998 filed by the present inventor. The inventor herein was inspired by King Camp Gillette the American businessman He invented a best selling version of the safety razor. Several models were in existence before Gillette's design. Gillette's innovation was the thin, inexpensive, disposable blade of “stamped” steel. Gillette is widely credited with inventing the so-called “razor and blades business model”, where razors are sold cheaply to increase the market for blades, but in fact he only adopted this model after his competitors did.

### BACKGROUND OF THE INVENTION

The present invention relates to novel improved blade means for grooming specific areas of user, for the purpose exfoliation and/or detailed shaving. In particular, the present invention relates to a reduced widths blade of 1 inch and less which blades are honed at the cutting edge. The honed blades were specifically invented for such shaving applications as the Bikini area, Groin area, Body area, Scalp area, Facial areas including (Goatee, Beard, Sideburns, Lip, Ear, Eyebrow, Nose, Cheeks & Forehead), and lastly Toes & Knuckles. The STILES™ Honed Blade will work in combination with other inventions of Sharidan Stiles found in both issued and pending patents pending to create a never been produced experience in the “World” of detailed shaving and/or exfoliating.

There is also a need in the medical field to improve on some aspects for wrinkle prevention via “exfoliation”, surgery preparation via “detailed shaving” & preparation for electrolysis, which requires “detailed” shaving such as around the nose and eyes prior to the electrolysis. There is still a need for a blade apparatus that has a “honed” cutting edge instead of stamped cutting edge 1 inch or less in width, for true exfoliation and detail. The STILES™ disposable razors with a unique razor head portion of sizes ranging between ⅛″, ¼″, ½″, which were invented and patented by the present inventor perform even more perfectly with these inventive “Honed” blades substituted for stamped blades.

The STILES™ Honed Blade is found to be not only an improvement but a necessity to be used for the non-disposable razor handle application, for which the blade cartridge holds a “fine” honed blade of quality, instead of a cheaper stamped blade. The present honed blade is almost seen as a requirement for the non-disposable handle, which costs more, and may employ different sized cartridges and thus result in individual shaving experience for the end user. To achieve detailed precision shaving and or exfoliating these honed blades provide the best quality and results for these same applications of use. This inventor has developed stamped blades and honed blades of different sizes less than 1″ inch width, to provide for different applications needed in the finest quality and more importantly achieve the detailed accuracy of exfoliating and shaving. This STILES™ Honed Blade Apparatus that employs this honed blade far exceeds smoothness and ease of use of razors that employ the stamped blades previously used, for both the Medical and non-medical Shaving Fields.

Attention is called to United States Letters Patents; U.S. Pat. No. 9,108,329; and published application US2002/0157258, both of which are believed to be different from the instant teachings.

### SETTING OF THE INVENTION

Many individuals wish to Exfoliate their skin and/or remove unwanted body hair for personal reasons maintaining their own individuality, like the Bikini area, Groin area, Body area, Scalp area, Facial areas such as: (Goatee, Beard, Sideburns, Lip, Ear, Eyebrow, Nose, Cheeks & Forehead), as well as Toes & Knuckles.

Likewise, those who desire a smooth, stubble free and unblemished surface within these pre-recited shaving areas, there still is little resort to possible solutions outside of depilatory, chemical creams, gels, electrolysis, waxing, threading or hair removal products all of which are painful and risky and are sorely lacking in terms of safety, efficiency, accuracy and convenience.

In short, there is a problem of exfoliating and/or shaving any and all of the supra named areas of the body, which for the purposes of the instant application are defined as areas of body hair within that region extending at least about from the dual vertices of the inverted triangular zone beginning proximate to each of the respective pubic bones, which demarcate the groin area, through and in between the legs until the distal edge or apex of the triangular zone within an individually predetermined space location in the fold of skin defined by the buttocks has never been squarely addressed and remains a longstanding need for those who wish to prevent visibility of pubic hair outside of clothing or from existing at all on the “Mons pubis”, or related areas on men. Difficulty is also found for hair removal or exfoliation in locations such as the Groin area, Body area, Scalp area, Facial area such as: (Goatee, Beard, Sideburns, Lip, Ear, Eyebrow, Nose, Cheeks & Forehead), and the Toes & Knuckles. The STILES™ Honed Blade Apparatus may be used to achieve personal gratification and/or improved hygiene, for which there are no options available until now.

It is well known that certain areas of people are susceptible to the development of hair. Razor blades and handles for the same were first developed for the facial areas and heads of men. Conventional or standard razor blades are generally at least about 1.5 inches wide, and this dimension is equally applicable to single, double, treble or any conventional variation of the number of blades stored in a blade head, as the same is known.

Standard razor blades have not evolved over the years to address the needs of both men and women. The Razor Industry became too big to see the Forest through the trees regarding the potential that was thought of in the early 70's by this inventor as a little girl not wanting to pluck her eyebrows. Since the advent of STILES™ Disposable Razors came onto the market the market has shown that there is a need for the Honed Blade Apparatus of this invention to improve the art of men's grooming that has been ignored drastically over the years. The same is true with respect to the shaving of women's private parts, totally ignoring the need for improved blades and improved razors to address this market.

Both Men and Women shaving products adhering to the standard or safety razor designs and sizes of the day seem to be directed at aspects of a old fashioned hair removal on ones body other than the Bikini area, Groin area, Body area, Scalp area, Facial area such as: (Goatee, Beard, Sideburns, Lip, Ear, Eyebrow, Nose, Cheeks & Forehead), then lastly Toes & Knuckles. This large area of focus includes both the legs and underarms, which are separate matters entirely. Likewise, alternate means have proven to have drawbacks since creams, gels, “chemicals” and electrolysis solutions have not proven sufficient for most users to date, there remains a relevant, untapped market with a strong demand and extreme need for alternatives of the teachings of the present invention.

In order to address the clearly longstanding need of providing a means for safely and effectively exfoliating and or removing hair from the aforementioned shall we call them special areas, the instant teachings are here-with offered for consideration and believed to constitute a modicum of progress in the pursuit of science and the useful arts on such basis.

### OBJECTS AND SUMMARY OF THE INVENTION

Accordingly it is an object of the present invention to provide a Honed Blade Apparatus with unique sizes of blades for placement into a cartridge or razor, to be the first safety razor that is able to have interchangeable blade heads of any given size for choice of the end user.

Another object is to provide a shaving apparatus having a width less than the conventional standard safety razor size for exfoliating and or shaving the Bikini area, Groin area, Body area, Scalp area, Facial area such as: (Goatee, Beard, Sideburns, Lip, Ear, Eyebrow, Nose, Cheeks & Forehead), then lastly Toes & Knuckles using a non-powered apparatus

A third object is to provide a razor blade that fits more easily and comfortably within the constraints of the confined body areas which include the Bikini area, Groin area, Body area, Scalp area, Facial area such as: (Goatee, Beard, Sideburns, Lip, Ear, Eyebrow, Nose, Cheeks & Forehead), the Toes & Knuckles, which blade is compatible with conventional handles, blade guards and related cutting edge shaving accouterments; and operates without batteries. Good for the environment & cost!

These and still further objects are defined in this specification and as recited in the claims appended hereto, whereby the teachings of the present invention are differentiated from conventional technology.

The foregoing objects are achieved in the Honed Blade Apparatus for exfoliating and or removing hair which apparatus includes a blade for exfoliating and or shaving, ranging from all sizes less than one inch, coupled with any ergonomic, or known handle member for closely adhering to a predetermined latitudinal orientation.

Briefly stated, the Honed Blade Apparatus for exfoliating and or removing unwanted hair is made up of a blade having a honed cutting edge width ranging from 1 inch and less of the surface area, in combination with any conventional attachment handle, and also disposable specialized handle structures such as the patented disposable razors of this inventor. with which the honed blade of this invention is compatible. A honed blade is one that has been sharpened on a whetstone, and usually has one or both edges tapered to a lesser thickness than the balance of the blade. This is as opposed to a stamped blade which is of uniform thickness.

According to a feature of the present invention comprises at least one honed Blade defined by a cutting edge having width of between about 0.1 and about 1.0 inches, alone or in a razor head. Various width single blades and a plurality of Honed Blades in cartridges for several applications, all with one non-disposable razor handle for the purpose of using interchangeable blade heads of different sizes for different applications are envisioned, as well as single or multiple blades mounted to a permanently attached handle for complete disposal.

Likewise, a method of using a STILES' Honed Blade Apparatus, includes the steps of providing a blade measuring from about 0.1 and about 1.0 inches and utilizing the same at a predetermined spatial angle in relation to a user's skin to remove, shave and or exfoliation is disclosed.

Similarly, a Honed Blade Apparatus, comprises providing a narrow width blade “honed” cutting edge previously defined having a fixed dimensional proportion in relation to a handle and combining the same with a handle to form an integral unit forms part of this invention.

The invention also contemplates a Honed Blade, as defined above and a means for removably fixedly attaching the blade to a non-attached handle member and if desired also applying blade guards and lubricant strips, to shave one's legs or face or to shave a uni-brow and face, or to shave eyebrows and bikini line.

### BRIEF DESCRIPTION OF THE DRAWINGS

FIG. 1 is a top view of the Honed Blade Apparatus according the teachings of this present invention,

FIG. 2 is a side view of the Honed Blade Apparatus according to the teachings of the present invention,

FIG. 3 is a front view of the shaving head that may include a set of Honed Blades Apparatus shown in FIG. 1,

### DETAILED DESCRIPTION OF THE INVENTION

The present inventor has discovered that in seeking enhanced precision in razor based hair removal, a smaller and or narrower width razor blade likewise bring the unexpected benefit of non-encroachment upon critical non-hair growing regions (such as the greater labial zone, or area of a women's body that is centered between the two narrow hair-groin passages running from the frontal region of the pubic hair through the legs towards the buttocks). To these ends, an appropriately sized and fitted shaving device is an asset for specific hair removal needs in the bikini line area and like wise may assist with related difficulty angled shaving zones. Similarly by providing a honed razor blade a customized shaving apparatus for specific needs has been developed without the need for specialized handles or like means, which comprise the mechanical integrity of the shaving system.

According to the teachings of the present invention the inventor has discovered that a razor blade that has a smaller honed blade width cutting edge for example any size between (0.10 to 1.0 inch) in comparison to the standard or conventional razor blade width of approximately (1.5 inches) and more easily and comfortably fits into and removes unwanted hair from a woman's bikini line area inerter alia and 1″ inch and less for Bikini area, Groin area, Body area, Scalp area, Facial area such as: (Goatee, Beard, Sideburns, Lip, Ear, Eyebrow, Nose, Cheeks & Forehead). This can be accomplished without having heightened angular and spatial constraints for the user.

As detailed above the driving force behind the instant discovery is the fact that the 1″ inch and Honed Blade Apparatus made up of a honed blade of less than 1 inch in width coupled to a handle is ideal for shaving the Bikini area, Groin area, Scalp area, Facial area such as: (Goatee, Beard, Sideburns, Lip, Ear, Eyebrow, Nose, Cheeks & Forehead) of one's body as portions of or the entire areas are smaller than the width of a conventional razor blade. This honed blade invention resulted because smaller and more spatially compact razor blade means, in combination with conventional technology for enclosure and mounting addresses a longstanding need while impacting significant related benefits to the shaver which result in less cuts and scrapes, and more accurate shave lines.

As defined herein “razor head” comprises a conventional blade razor blade housing and mounting technology such that applicant's novel miniaturized blade configuration is positioned to exfoliate and/or shave a user. Like wise Honed Blade Apparatus” is used to indicate a blade or razor head in conjunction with a handle. The honed blade is referred to as a honed blade while the honed blade apparatus includes a handle permanently or removeably attached.

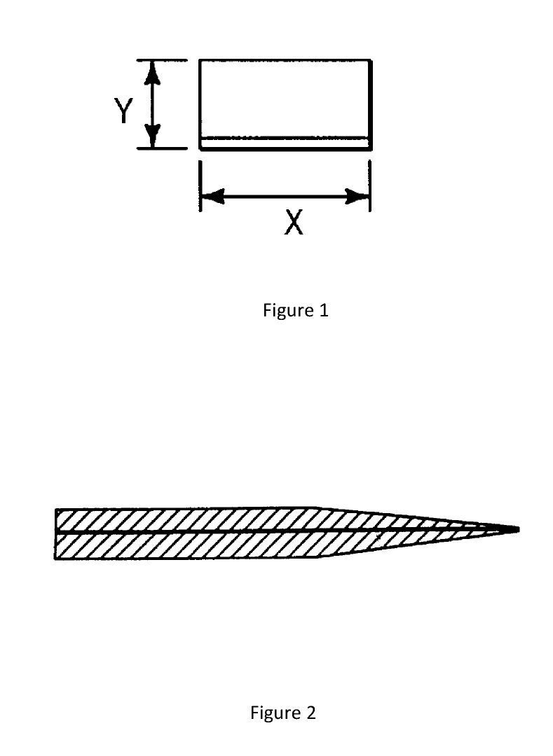

Referring now to FIG. 1, Honed Blade of this invention is constructed of conventional materials, selected from the group consisting of known metals as steel and stainless steel or alloys of steel, Shape memory Alloys (SMAs) and ceramic and is preferentially defined by a set dimensional requirement, whereby a predetermined ratio of length X to width Y is maintained.

For example, according to preferred embodiments, the blade shown in top plan view in FIG. 1 is between about 0.1 inches and 1.0 inch in width in preferred embodiments, as a measurement of the (X) dimension. While the (Y) dimension can also range between 0.1 inches and 1.0 inches. The preferred ratio is of Y being equal to ½ X.

Since the Honed Blade of between about 0.1 and 1.0 in width results in a razor head which will be more naturally, comfortably and safely can be angled to shave the bikini line area, it likewise betters serves the narrow hair growing passages that run between women's legs toward the buttocks. When removing unwanted hair from such uniquely feminine and delicate skin areas, it is imperative to use extreme caution so as not to expose non-hair growing regions to the cutting edges of the razor head. The same holds true for the curved even smaller delicate areas of ones body such as the Scalp area, Facial area such as: (Goatee, Beard, Sideburns, Lip, Ear, Eyebrow, Nose, Cheeks & Forehead)

A smaller and narrower razor head like wise brings the unexpected benefit of non-encroachment upon critical non-hair growing regions (such as the greater labial zone, or area of a woman's body that is centered between the two narrow hair-growing passages running from the frontal region of the pubic hair through the leg towards the buttocks) which is essential in the event that a woman elects manual hair-removal. Since creams, gels, and electronic solutions have not proven sufficient for most women to date, there remains a longstanding need for the teachings of the present invention. The same concern is that one would not use a conventional razor effectively on Scalp art, Facial area such as: (Goatee, Beard, Sideburns, Lip, Ear, Eyebrow, Nose, Cheeks & Forehead)

It will be appreciated by persons skilled in the art that numerous variations and or modifications may be made to the invention as shown in the specific embodiments without departing from the spirit or scoped of the invention as broadly described. The present embodiments are, therefore to be considered in all respects as illustrative and not restrictive.

### DETAILED DESCRIPTION OF EMBODIMENTS OF THE HONED STILES™ BLADE APPARATUS

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Embodiments of the present invention relate to Honed Blade Apparatus that will have additionally a honed cutting edge of less than one inch in width for removing unwanted body hair and or exfoliating. A “honed” blade as used herein is a blade that has been sharpened by a honing process, such as on by one or more grinding or polishing wheels. A honed blade has been found to be sharper and safer than the stamped blades that are less costly and typically used within razor blade cartridges.

In the honing process comprises of each pair of wheels rotates about axes that extend parallel to the edge of the blade strip. The abrading wheels may be controlled to grind the razor edge of the blade strip to a first controlled facet with a predetermined sharpened angle. The included angle of the first controlled facet may be between 5° to 30° More particularly, the included angle of the first facet may be 6, 7, 8, 9, 10, 11, 12, 13, 14, 15, 16, 17, 18, 19, 20, 21, 22, 23, 24, 25, 26, 27, 28, 29 degrees, or any set of included angles there between.

The facet length for the first controlled facet may be, for example, 0.005 inches or greater. For example, the facet length may be 0.006, 0.007, 0.008, 0.009, 0.01, 0.015, 0.02, 0.025, 0.030 up to 0.100 inches or any facet length there between. The blade strip may then be further smoothed by using a second set of abrading wheels that have finer grind than the first set of abrading wheels. The second set of abrading wheels may smooth the first controlled facet, or alternatively create a second facet on the first facet that provides and even sharper edge. For example, the second facet may have an included angle between 5° to 30° More particularly, the included angle of the second facet may be 6, 7, 8, 9, 10, 11, 12, 13, 14, 15, 16, 17, 18, 19, 20, 21, 22, 23, 24, 25, 26, 27, 28, 29 degrees, or any set of included angles there between. The facet length for the second controlled facet may be, for example, 0.005 inches or greater. For example, the facet length may be 0.002, 0.003, 0.004, 0.005, 0.006, 0.007, 0.008, 0.009, 0.01, 0.015, 0.02, 0.025, 0.03 inches or any facet length there between.

Once the blade edge has been honed by the first and second set of abrading wheels, it may be subjected to a finish honing step to form a final tip length. For example, the final tip length of the honed blade may be, for example, about 0.001 inch. Of course, the final tip may also be other lengths, such as 0.0005, 0.0006, 0.0007, 0.0008, 0.0009, 0.002, 0.003, 0.004 inches.

Blades may be made from a variety of different materials. For example, Solingen blades may be constructed from Solingen steel. Stainless steel for blades may be a type of martensitic stainless steel having chromium between 12 and 14.5%, a carbon content of approximately 0.6%, and the remainder being iron and other trace elements. Razor blades can also be made from carbon steel, tool steel and alloy steel. Other less common materials used in knife blades include: cobalt and titanium alloys, obsidian, and plastic may be employed as well.

While a metal razor or handheld blades have been discussed above, embodiments are not limited to only razor blades made of metal. For example, razor blades made from ceramic substrates are also included within embodiments of the invention. These ceramic blades can be produced as honed blades by following the same process described above to create honed metallic blades. For example, the ceramic substrate may be abraded in two-step process using two different abrading wheels, a first rough-honing wheel and a second smoothing wheel to form a sharpened edge. The ceramic blade may then be treated with a finish-honing step to create the final tip length. In one embodiment, the ceramic blade is heat-treated at high temperature to anneal the ceramic material. For example, the ceramic blade may be heat treated to about 1000° C. in an annealing step.

In one embodiment, the ceramic blade is made from zirconium dioxide (ZrO₂), also called zirconia. “This is the future technology for a biodegradable blade”.

Blades as used herein may also be coated with a variety of coatings to increase the sharpness and durability of the blade. For example titanium nitride, titanium carbon nitride (TiCN), titanium aluminum nitride (TiAlN or AlTiN), and titanium aluminum carbon nitride may be used to coat a metallic or ceramic blade. These coatings may also be used in one or more layers on top of one another provide an advantageous shaving blade. For example, a metallic blade may first be coated using vapor deposition techniques with a thin layer of titanium nitride. The same blade may then be coated with a second layer of another coating, for example, titanium carbon nitride or titanium aluminum nitride to produce a strong and durable shaving edge. These blades may also be coated with a layer of Polytetrafluoroethylene (Teflon) to help the blade maintain a clean, nonstick surface that is easy to clean.

FIG. 1 shows a top view of a razor blade 10 having a width X and a depth Y. As discussed above, the width X of the blade should be less than one inch, for example 1 inch, 6/8 inch, ½ inch, ⅜ inch, ¼ inch, ⅛ inch or any size or range of sizes in between any of these sizes or less. The blade has a cutting portion and a rear portion or may have two-sided cutting portion.

FIG. 2 shows a side view of an embodiment of the razor blade illustrated in FIG. 1. The blade includes the rear portion and a first facet on the cutting portion that comprises the sharpened edge for shaving.

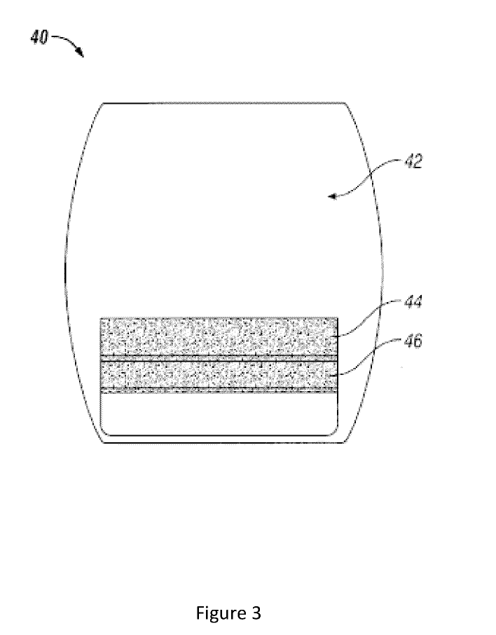

It should be realized that the blade might be incorporated into a razor cartridge as shown in FIG. 3. FIG. 3 is a front view of one embodiment of a shaving head 40. The shaving head 40 includes a glide surface 42 a first blade 44 and a second blade 46. Although two shaving blades are illustrated in this figure, this is only an example and more or less blades are used in various embodiments. In the embodiment illustrated in FIG. 3 the two blades are held in the shaving head 40 in a parallel alignment and are spaced apart from one another a sufficient distance to allow the hair removed by the first blade 44 to be cleared from the cutting edge as the shaving head moves along. Such alignments are common in the shaving industry and any suitable gap between the blades 44, 46 can be used. The shaving head 40 illustrated shows a glide surface 42 that is significant in comparison to the area of the two blades 44, 46. Changing the size of the glide area can vary the ratio. 42. Through adjustment of the size of the glide area 42 the overall size of the shaving head 40 can be increased or decreased depending on the application of the shaving head 40 while balancing the size reduction against the comfort and control provided by the glide area. Certain embodiments apply material to the glide area for soothing or improved gliding over the body zone to be shaved. Such material includes lotions, balms, ointments, medicated lotions among others.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed:

1. A Honed Blade Apparatus for exfoliating and or shaving of a user comprising in combination:
a. at least one honed razor blade for cutting, disposed in a razor blade head assembly having a predetermined angled spaced relationship to,
b. a handle member, created to fit the blade head and connected thereto.
wherein the at least one blade is defined by the width of the honed cutting edge about 0.1 and 1.0 inch.

2. The apparatus of claim 1, wherein the handle member is readily detachable from the razor blade head assembly which head assembly is disposable.

3. The apparatus as defined in claim 1, wherein said at least one Honed Blade is a unitary member selected from metallic and ceramic blades having a width between 0.10 and 1.00 inch.

4. The apparatus of claim 1 wherein there are two honed blades in the razor head assembly.

5. The apparatus as defined in claim 1, wherein there are at least two Honed Blades in a razor blade head assembly having a cutting edge width of at about 0.10 inch.

6. The apparatus as defined in claim 1, wherein said razor head assembly has at least one Honed razor blade having a cutting edge width of at about 0.20 inches.

7. The apparatus as defined in claim 1, wherein said razor head assembly has at least one Honed razor blade having a cutting edge width of at about 0.30 inches.

8. The apparatus as defined in claim 1, wherein said razor head assembly has at least one Honed razor blade having a cutting edge width of at about 0.40 inches.

9. The apparatus as defined in claim 1, wherein said razor head assembly has at least one Honed razor blade having a cutting edge width of at about 0.50 inches.

10. The apparatus as defined in claim 1, wherein said razor head assembly has at least one Honed razor blade having a cutting edge width of at about 0.60 inches.

11. The apparatus as defined in claim 1, wherein said razor head assembly has at least one Honed razor blade having a cutting edge width of at about 0.70 inches.

12. The apparatus as defined in claim 1, wherein said razor head assembly has at least one Honed razor blade having a cutting edge width of at about 0.80 inches.

13. The apparatus as defined in claim 1, wherein said razor head assembly has at least one Honed razor blade having a cutting edge width of 0.90 inches.

14. The apparatus as defined in claim 1, wherein said razor head assembly has at least one Honed razor blade having a cutting edge width of about 1.00 inches.

15. A honed razor blade of a width ranging from 0.1 inches to 1.00 inches and having one to two facets on the cutting edge.

16. A honed razor blade having a length and a width, of a width ranging from 0.1 inches to 1.00 inches as in claim 15, wherein the length is one half the width.

17. A honed razor blade as in claim 15 of a width of about 0.25 inches

18. A honed razor blade having a length and a width, of a width ranging from 0.1 inches to 1.00 inches wherein the length is one half the width and the length is 0.5 inches and the length is 1.0 inch.

19. A honed razor blade as in claim 15 having a width of about 0.5 inches

20. A honed razor blade as in claim 15, wherein the blade has a width of about 0.75 inches.
